(19) United States
(12) Patent Application Publication
(10) Pub. No.: US 2016/0326703 A1
(43) Pub. Date: Nov. 10, 2016

(54) ADJUSTABLE TELESCOPIC FORMWORK FOR PAVING WITH LINEAR OR AXIAL AND RADIAL GEOMETRIC ALIGNMENT

(71) Applicant: Afonso MOREIRA SERRO, Lisboa (PT)

(72) Inventor: Manuel Filipe LOURENCO SERRO, Lisboa (PT)

(21) Appl. No.: 15/106,320

(22) PCT Filed: Dec. 19, 2014
(86) PCT No.: PCT/PT2014/000076

§ 371 Date: Jun. 20, 2016

(30) Foreign Application Priority Data
Dec. 19, 2013 (PT) 107373

(51) Int. Cl. E01C 19/50; B28B 7/02; E04G 11/36

(52) U.S. Cl. CPC E01C 19/502; E04G 11/36; B28B 7/02

(57) ABSTRACT

The present invention relates to an adjustable telescopic formwork with linear or axial and radial geometric alignment for pavement construction which materials lose volume in the dehydration step until reaching the solid state and consists in obtaining a light and resistant formwork. The present invention comprises at least two blades, one outer (a), which at its upper edge has a tab (l) for supporting various equipments for vibrating, cutting and grinding the materials that are confined by it; and another inner (b) that has a telescopic function which allows to be regulated millimetrically by a manual or electric adjustable vertical screw (c). The present invention is intended to confine various types of materials, especially cement concrete, ensuring his perfect levelling, ensuring very low margins of unevenness and is mainly intended for the construction of roads, airports, ports and industrial floorings.

### TECHNIQUE FIELD AND PRIOR ART OF THE INVENTION

The present invention relates to an adjustable telescopic formwork with linear or axial and radial geometric alignment for pavement construction which materials lose volume in the dehydration step until reaching the solid state. The aim is to achieve a light and resistant formwork.

In search of the prior art invention, the patent documents U.S. Pat. No. 4,202,145, DE3727780 and DE4329910 have been identified. These documents relate to telescopic formwork for paving. They are different from the present invention since they do not have an inner blade (b) to which are welded two stop bars (f) allowing their rapid attachment to the ground by a nail (g), thereby assuring their perfect tightness. This new application makes it possible to monitor all unevenness of the foundation. Existing formworks can only be levelled by lifting the slab base by means of shims and stop bars, welded or tied, leaving empty spaces without resistance (to bending/traction), areas at the lower edge of the slabs, subsequently leading to its rupture and differential settlement.

So its telescopic function allows the reposition of the initial topographic elevation at any stage of the construction or loss of volume of the materials, whether the unevenness is caused by human intervention, or caused by chemical and physical action of the materials or by the elastic movements of the foundations.

It adds that the telescopic function allows in a quick and practical way, through easy assembly and disassembly, to correct all the imperfections of the bases (natural ground, selected soils, deformable materials, etc.), as well as the radial placement to implement curves and the axial placement to implement bumps and depressions with variable topographic elevations since the formworks have different dimensions (FIG. 4). In the axial configuration, since the formworks follow topographical elevations which form convex and concave curves (bumps and depressions) the outer telescopic blade has an angular cut (FIG. 5) to allow that, in its vertical adjustment, it will not be anchored (stuck) in the blade of the previous or next formwork, as the lower blades (b) may be slightly overlapped.

The present invention works preferably with the system of semi-continuous concrete/slab-foundation, with joints provided with load transfer plates, but can also be used in concrete slabs where the load transfer elements in the joints are bars or continuous reinforcements (h), which are placed through one of the openings (m), which besides allowing their fixation do not prevent the vertical movement to achieve the above described levelling.

The present invention can also be applied to deformable or resilient materials (EPS, XPS, rubbers, acoustic and thermal materials, etc.) without losing the characteristics described above, simply by the effect of placing a removable reinforcement bar (i) that is anchored to an outer plate (j) to the formwork, resting on the said deformable and resilient material (FIG. 5).

The present invention has the following advantages over the prior art:
a) execution speed (large areas of daily production);
b) low manufacturing cost;
c) utilization of low environmental impact materials (iron, wood, etc.);
d) great durability;
e) savings in manpower (assembly only with teams of two men);
f) possibility of utilization in industrial areas of robotic forklifts;
g) reduction of running costs especially in road, port and airport pavements;
h) higher average speed of transport of people and goods at a lower cost per kilometre;
i) reduction of accidents.

### DESCRIPTION OF THE INVENTION

The present invention relates to an adjustable telescopic formwork with linear or axial and radial geometric alignment for pavement construction which materials lose volume in the dehydration step until reaching the solid state and consists in obtaining a light and resistant formwork. The innovation of the present invention relates to the fact that it is obtained by using in its manufacture various types of materials (steel, plastic, wood, etc.) of easy placement and that allows at the same time by its telescopic movement in the vertical direction to adjust accurately in the order of millimetres any pavement area, at any stage of volume reduction of the constituent materials that are confined thereof (concrete, mortar, plaster, sand/gravel stabilized, etc.).

The present invention is intended to confine various types of materials, especially cement concrete, ensuring its perfect levelling, assuring very low margins of unevenness at most 2 mm, verified by a ruler of 6 m and is intended primarily to the construction of roads, airports, ports and industrial flooring.

The present invention consists of at least two blades:
an outer blade (a), which at its upper edge has a tab (l) for supporting various equipments for vibrating, cutting and grinding of the materials confined thereof; and
an inner blade (b), which has a telescopic function which allows to be millimetrically adjusted by a manual or electric adjustable vertical screw (c) by means of a motor incorporated with a laser level.

The above technical features make possible, by the present invention, the adjustment and the levelling at all stages of volume loss of the materials either by hydration of the water as by chemical and physical transformations thereof, thus ensuring the quality of a final levelling to the millimetre.

The formwork, object of the present invention, allows the correction of topographic levelling in any implementation stage of the pavements, whatever the unevenness that may occur, either by volume loss of the materials (lowering, “slump”) or by the movements of soils of the base and sub-base or for any accident during the execution (strokes with machines, for example).

The directional and vertical alignment is ensured by the hinge (d) fixed by an axis that allows the rotation in both a clockwise direction and in the reverse direction, thereby forming an accurate angle of 90 degrees on the slab base and simultaneously sealing it completely. The fact that it follows the irregularities and unevenness of the foundation prevents the passage of the constituent materials of the slab (sand, stone, concrete, etc.), preventing the occurrence of voids at the base thereof.

The technical effect of following the irregularities and unevenness of the foundation, allowing the tightness on the slab base, enables efficient placement of inductor and tightness joint elements (“water stop”) (e) that prevent the destruction of the foundations, so avoiding the disastrous pumping phenomena (“pumping”), with the consequent breakage of the slabs.

The present invention enables the exact distribution of the loads on the transmission elements (load transfer plates, load transmission bars, reinforcements, etc.). The perfect base angle obtained by these formworks increases the strength of the lower edge of the slab, allowing a more safely stress distribution, saving the slab and the foundation.

The above mentioned fixing hinges besides allowing the perfect directional and vertical alignment of these formworks also enable the connection between them easily and quickly. Since they are not apparent, they are not in contact with the concrete or other materials, not creating therefore anchor points which allow the free retraction thereof. Thereby eliminating shrinkage cracks outside the load transfer supports (load transfer plates load transfer bars, continuous reinforcements, concrete with fibres, etc.), assuring that the slabs have the shape and behaviour required in the project sizing.

### DESCRIPTION OF THE FIGURES

FIG. 1—sectional representation of the embodiment of the linear telescopic formwork with joint inductor. The formwork comprises an adjustable outer blade (a) overlapping on another inner blade (b) attached to the base by a stop bar (f) and by a fixing nail (g) and connected and aligned with each other by a rotational hinge (d). The telescopic adjustment which allows the millimetric levelling is achieved through a vertical screw (c), this screw can be a worm screw; the blade (b) rests upon an inductor and tightness joint (e); the blade (a) has a horizontal constituent edge (l) for supporting compaction and levelling machinery and tools. In the case of telescopic formwork on resilient materials is added a removable stop bar (i) and a continuous plate (j) which support the formworks and which is attached via a spring (q). In the radial placement these formworks are subject to tension by a steel cable (p), held by two rings (o), which will ensure a peripheral arc obtained by the angle formed over the radius of the circle (curve).

FIG. 2—top plan representation of the radial telescopic formwork with joint inductor. The formwork comprises an adjustable overlapped outer blade (a), a stop bar (f) and a fixing nail (g) and rotational hinge (d). Represented are the inductor (e), the removable stop bar (i), which supports the formworks, is attached by means of a spring (q) to said stop bars (f) and rings (o).

This preferred embodiment is intended for the placement on resilient materials.

FIG. 3—top plan representation of the axial telescopic formwork, with joint inductor, wherein the blade (a-2)—preferred embodiment of the blade (a) with an angular cut—allows to create a rotation in the fitting of the formworks, assuring a perfect arch without creating friction or anchoring when implementing bumps or depressions.

FIG. 4—perspective representation of the radial telescopic formwork with joint inductor.

FIG. 5—perspective representation of the axial telescopic formwork, the blade (a) has the angular cut (n), in this figure it is shown this preferred embodiment of this blade (a-2), which allows to create a rotation in the fitting of the formworks, assuring a perfect arch without creating friction or anchoring, when implementing bumps or depressions, and the remaining components are identical to those shown in FIGS. 1, 2 and 6.

FIG. 6—representation of the radial view of the radial telescopic formwork, with joint inductor, in which are represented the blade (a), the inductor (e) and the steel cable (p).

FIG. 7—representation of the axial view of the axial telescopic formwork with joint inductor.

FIG. 8—sectional representation of the linear telescopic formwork embodiment. The formwork comprises an adjustable outer blade (a) overlapping on another inner blade (b) attached to the base by a stop bar (f) and a fixing nail (g) and connected and aligned with each other by a rotational hinge (d) and two openings on the upper and lower blades (m) for placement of bars or reinforcements (h). The telescopic adjustment which allows the millimetric levelling is achieved through a vertical screw (c); the blade (b) rests upon an inductor and tightness joint (e); the blade (a) has a constituent horizontal edge or tab (l) to support compaction and levelling machinery and tools. Represented are also the rings (o) and the steel cable (p).

FIG. 9—top plan representation of the radial telescopic formwork embodiment in which is identified the adjustable overlapped outer blade (a).

FIG. 10—top plan representation of the axial telescopic formwork in which is represented the blade (a-2) of FIG. 5.

FIG. 11 —perspective representation of the radial telescopic formwork embodiment.

FIG. 12—perspective representation of the axial telescopic formwork, the blade (a-2) having an angular cut (n) that allows to create a rotation in the fitting of the formworks, assuring a perfect arch without creating friction or anchoring wham implementing bumps or depressions. Also represented is the inner blade (b) attached to the base.

FIG. 13—representation of a set of blades for bumps.

FIG. 14—representation of the standard blades set.

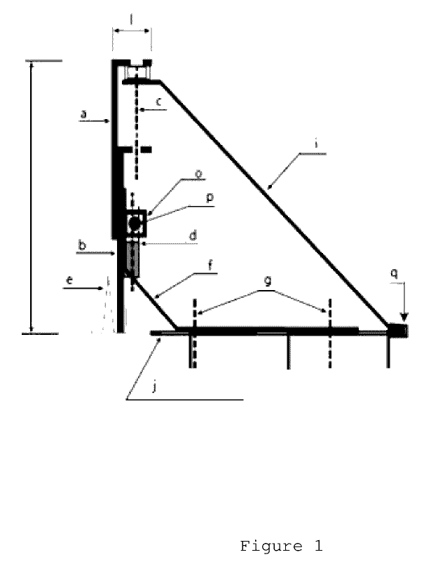

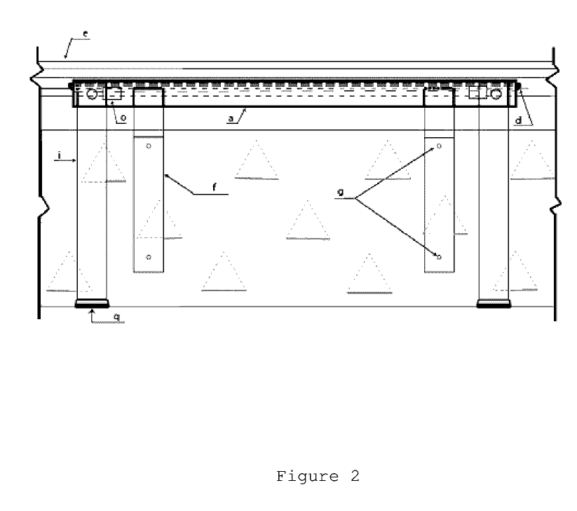

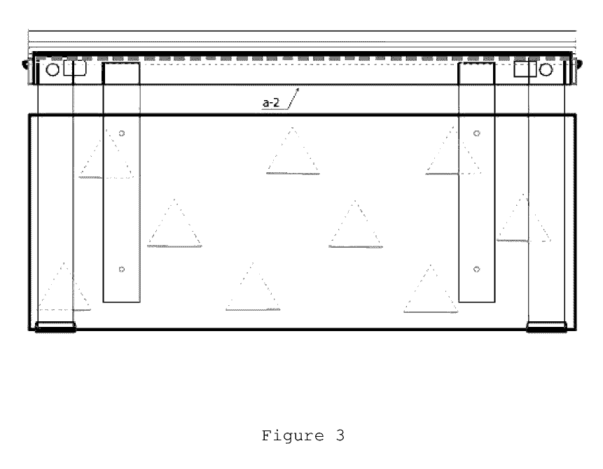

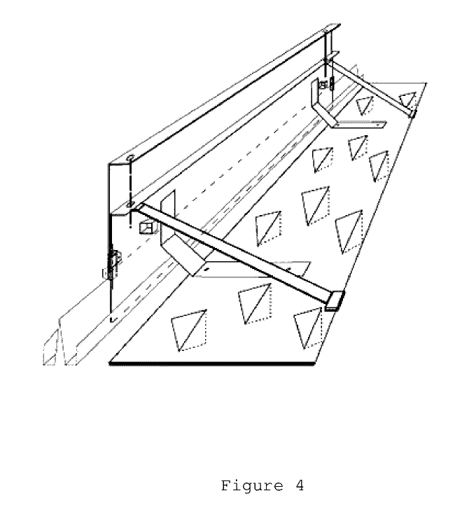

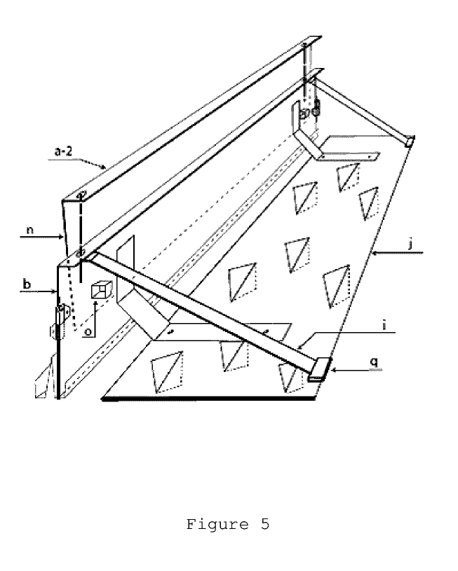

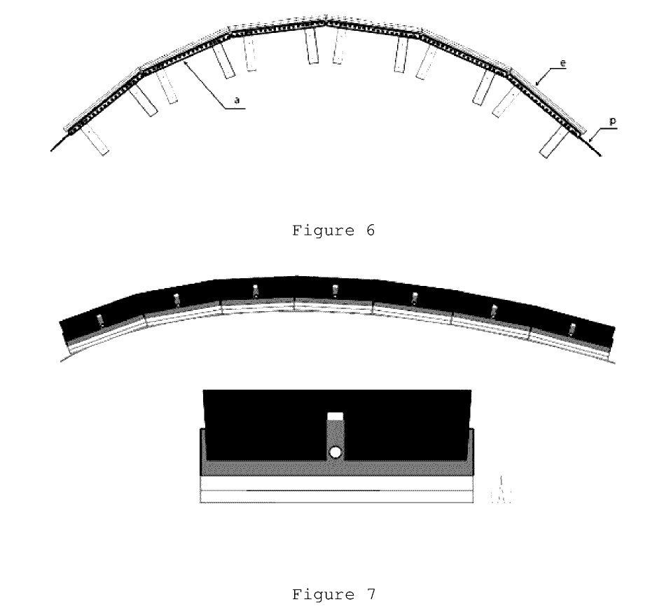

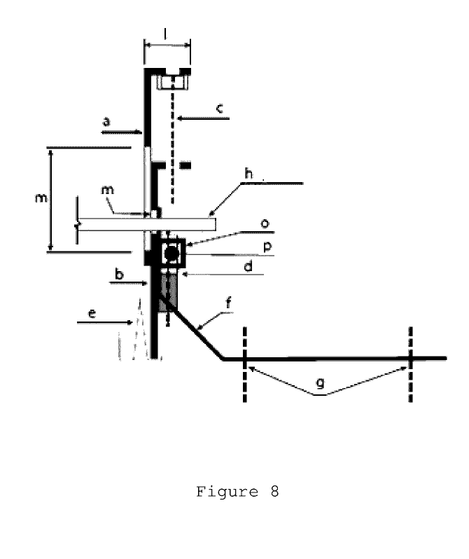

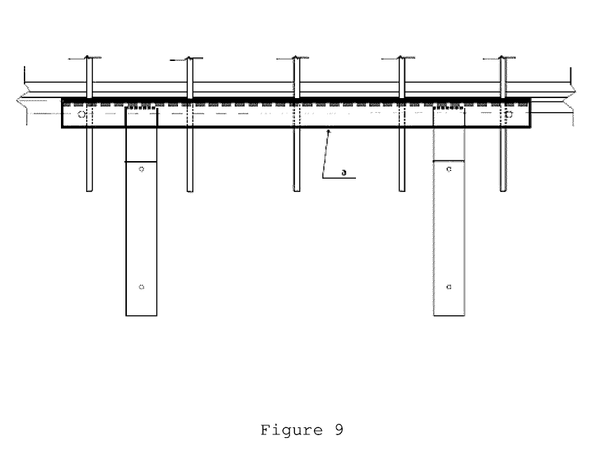

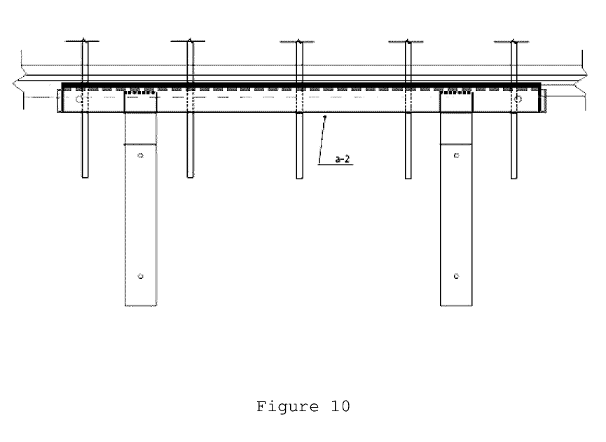

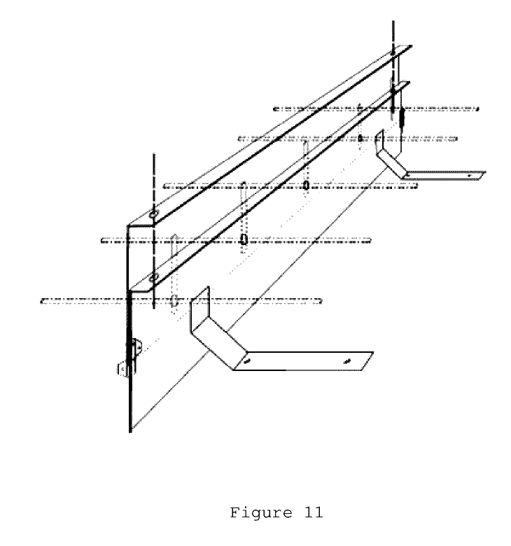

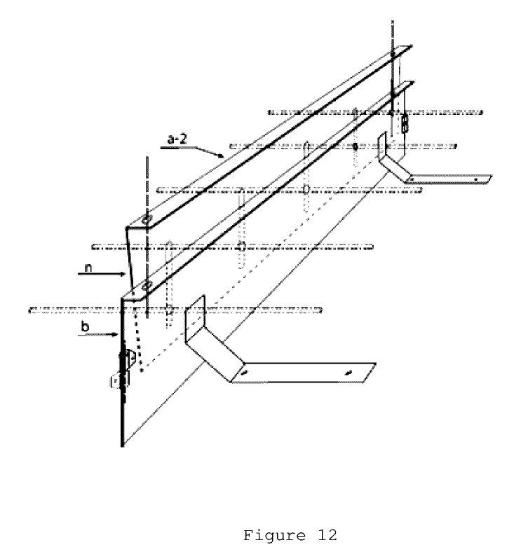

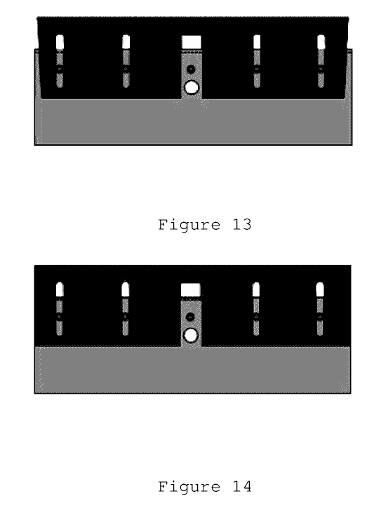

Note—FIGS. 8, 9, 10, 11 and 12 are identical to FIGS. 1, 2, 3, 4 and 5, respectively, wherein the first ones there is not the removable stop bar (i) and a continuous plate (j) which supports the formworks and which is attached via a spring (q) to said stop bars (f) allowing the placement of the telescopic formwork on resilient materials.

1. Adjustable telescopic formwork for paving with linear or axial and radial geometric alignment characterized by comprising at least one outer blade (a) overlapped and adjustable, which at its upper edge has a tab (l) placed over at least another inner blade (b) adjusted by a vertical screw (c) and which rests upon an inductor (e); the inner blade (b) is fixed to the base by at least a stop bar (f) and a fixing nail (g) and connected and aligned with each other by a rotational hinge (d), which is fixed by an axis forming an angle of 90 degrees at the base; steel cable (p) secured by two rings (o).

2. Formwork according to claim 1 characterized in that the blade (a) has an angular cut (n).

3. Formwork according to claim 1 characterized in that the vertical screw (c) is manual or electrical adjustable, by means of a motor incorporated with a laser level.

4. Formwork according to claim 1, characterized by presenting two openings (m), upper and lower, in the blades for placement of bars or reinforcements (h).

5. Formwork according to claim 1 characterized by having a removable reinforcement bar (i) anchored to an outer plate (j).
